(19) United States
(12) Patent Application Publication
(10) Pub. No.: US 2023/0138235 A1
(43) Pub. Date: May 4, 2023

(54) SOURCE DRIVER, DISPLAY DEVICE AND DRIVING METHOD

(71) Applicant: Shenzhen China Star Optoelectronics Semiconductor Display Technology Co., Ltd., Shenzhen (CN)

(72) Inventors: Fengcheng XU, Shenzhen (CN); Yuhua CHANG, Shenzhen (CN); Mingjong JOU, Shenzhen (CN); Bin ZHAO, Shenzhen (CN); Xin ZHANG, Shenzhen (CN); Jun ZHAO, Shenzhen (CN)

(21) Appl. No.: 17/431,156

(22) PCT Filed: Dec. 29, 2020
(86) PCT No.: PCT/CN2020/140913

§ 371 Date: Aug. 14, 2021

(30) Foreign Application Priority Data
Mar. 22, 2020 (CN) 202010204852.8

(51) Int. Cl. G09G 3/20

(52) U.S. Cl. CPC G09G 3/20; G09G 2320/0233; G09G 2310/0275; G09G 2330/02; G09G 2300/0452; G09G 2300/0426; G09G 2320/0242

(57) ABSTRACT

The present disclosure provides a source driver, a display device, and a driving method. A plurality output channels of at least one source driver are grouped into a plurality of groups, and the plurality of output channel groups are provided with at least one multi-level voltage compensation unit. The at least one multi-level voltage compensation unit is configured to output compensation voltages, and then data voltages are outputted. As such, pixels in the display device can have the same charging voltage in the same time.

### TECHNICAL FIELD

The present disclosure relates to the display technology field, and more particularly to a source driver, a display device and a driving method.

### BACKGROUND ART

Currently, with the increasing of the size of a display device, a resolution of the display device is also increasing from HD (a resolution of 1280×720) to full HD (a resolution of 1920×1080), then from full HD (a resolution of 1920×1080) to ultra HD (a resolution 3840×2160), and then from ultra HD (a resolution 3840×2160) to 1G1D 8K (a resolution of 7680×4320). When the display device needs to meet the requirements of a large size, a high resolution, and a high refresh rate, a charging time of the display device is getting shorter and shorter. Pixels in different areas of the display device have charging differences due to different wire impedances in a fanout area of the display device. An uneven brightness (mura) problem occurs when an image is displayed.

In the traditional technology, an output data delay compensation (ODDC) method is used for solving the display problem due to the different wire impedances in the fan-shaped area of the display device. That is, output channels of a source driver corresponding to wires having smaller impedances in the fan-shaped area delay output data signals, so that all pixels have the same charging time. However, impedance distributions of the wires in different areas of the fan-shaped area of the display device are different. The ODDC method cannot solve the mura problems in various display devices.

### Technical Problem

An objective of the present disclosure is to provide a source driver, a display and a driving method for solving the display problem due to different impedances of wires in at least one fan-shaped area of a display device. Furthermore, the source driver can be applied to various display devices having different impedance distributions of wires in fan-shaped areas.

### Technical Solution

To achieve the above-mentioned objective, the present disclosure provides a display device. The display device includes a display panel and at least one source driver electrically connected to the display panel. The display panel has a display area and at least one fan-shaped area located outside the display area. The display area includes a middle display area and a first display area and a second display area located at opposite sides of the middle display area. A plurality of sub-pixels are disposed in the display area of the display panel. A plurality of wires are disposed in each of the at least one fan-shaped area of the display panel. Each of the at least one source driver includes a plurality of output channel groups. Each of the output channel groups includes at least one output channel Each of the at least one output channel is configured to output a data voltage. Each of the plurality of wires is configured to transmit the data voltage outputted by one of the at least one output channel A part of the plurality of wires are electrically connected to the sub-pixels in the middle display area, a part of the plurality of wires are electrically connected to the sub-pixels in the first display area, and a part of the plurality of wires are electrically connected to the sub-pixels in the second display area. The plurality of output channel groups are provided with at least one multi-level voltage compensation unit. Each of the at least one multi-level voltage compensating unit is configured to output compensation voltages of N levels. N is an integer greater than or equal to 2. When at least one of the plurality of output channel groups is switched to an i-th level of the at least one multi-level voltage compensation unit, at least one data voltage outputted by the at least one output channel of the at least one of the plurality of output channel groups which is switched to the i-th level is a voltage which is compensated by one of the compensation voltages corresponding to the i-th level. i is an integer greater than or equal to 1 and smaller than or equal to N.

In the display device, in the same multi-level voltage compensation unit, difference values of the compensation voltages corresponding to two adjacent levels are equal.

In the display device, the at least one multi-level voltage compensation unit is provided between two adjacent ones of the plurality of output channel groups.

In the display device, each of the at least one multi-level voltage compensation unit includes a ground terminal, a voltage level input terminal, a plurality of voltage dividing units, and a plurality of voltage level output terminals. The plurality of voltage dividing units are connected in series between the ground terminal and the voltage level input terminal. Each of the plurality of voltage level output terminals is disposed between two adjacent ones of the plurality of voltage dividing units.

A driving method of a display device is provided. The display device includes a display panel and at least one source driver electrically connected to the display panel. The display panel has a display area and at least one fan-shaped area located outside the display area. The display area includes a middle display area and a first display area and a second display area located at opposite sides of the middle display area. A plurality of sub-pixels are disposed in the display area of the display panel. A plurality of wires are disposed in each of the at least one fan-shaped area of the display panel. Each of the at least one source driver includes a plurality of output channel groups. Each of the output channel groups includes at least one output channel. Each of the at least one output channel is electrically connected to a corresponding one of the plurality of wires. A part of the plurality of wires are electrically connected to the sub-pixels in the middle display area, a part of the plurality of wires are electrically connected to the sub-pixels in the first display area, a part of the plurality of wires are electrically connected to the sub-pixels in the second display area. The plurality of output channel groups are provided with at least one multi-level voltage compensation unit. Each of the at least one multi-level voltage compensating unit is configured to output compensation voltages of N levels. N is an integer greater than or equal to 2. The method includes steps of: switching one of the plurality of output channel groups to an i-th level of the at least one multi-level voltage compensation unit, wherein i is an integer greater than or equal to 1 and less than or equal to N; outputting a data voltage by the at least one output channel of the one of the plurality of output channel groups; and transmitting the data voltage to the plurality of sub-pixels of the display panel via the plurality of wires in the at least one fan-shaped area, wherein the sub-pixels in the first display area of the display panel, the sub-pixels in the second display area of the display panel, and the sub-pixels in the middle display area of the display panel have the same charging voltage in the same time; wherein the data voltage outputted by the at least one output channel of the one of the plurality of output channel groups which is switched to the i-th level is a voltage which is compensated by one of the compensation voltages corresponding to the i-th level.

In the driving method of the display device, values of the compensation voltages of switching the plurality of output channel groups of the at least one source driver to levels of the at least one multi-level voltage compensation unit are decreased gradually in a direction from the first display area of the display panel and the second display area to the middle display area.

In the driving method of the display device, values of the compensation voltages of switching the plurality of output channel groups of the at least one source driver to levels of the at least one multi-level voltage compensation unit are decreased or increased gradually in a direction from the first display area of the display panel to the second display area.

In the driving method of the display device, the at least one multi-level voltage compensation unit is provided between two adjacent ones of the plurality of output channel groups.

In the driving method of the display device, each of the at least one multi-level voltage compensation unit includes a ground terminal, a voltage level input terminal, a plurality of voltage dividing units, and a plurality of voltage level output terminals, the plurality of voltage dividing units are connected in series between the ground terminal and the voltage level input terminal, and each of the plurality of voltage level output terminals is disposed between two adjacent ones of the plurality of voltage dividing units.

A source driver of a display device is provided. The display device includes a display panel. The display panel is electrically connected to at least one source driver. The display panel has a display area and at least one fan-shaped area located outside the display area. The display area includes a middle display area and a first display area and a second display area located at opposite sides of the middle display area. A plurality of sub-pixels are disposed in the display area of the display panel. A plurality of wires are disposed in each of the at least one fan-shaped area of the display panel. Each of the at least one source driver includes a plurality of output channel groups. Each of the output channel groups includes at least one output channel. Each of the at least one output channel is configured to output a data voltage. Each of the plurality of wires is configured to transmit the data voltage outputted by one of the at least one output channel A part of the plurality of wires are electrically connected to the sub-pixels in the middle display area, a part of the plurality of wires are electrically connected to the sub-pixels in the first display area, and a part of the plurality of wires are electrically connected to the sub-pixels in the second display area. The plurality of output channel groups are provided with at least one multi-level voltage compensation unit. Each of the at least one multi-level voltage compensating unit is configured to output compensation voltages of N levels. N is an integer greater than or equal to 2. When at least one of the plurality of output channel groups is switched to an i-th level of the at least one multi-level voltage compensation unit, at least one data voltage outputted by the at least one output channel of the at least one of the plurality of output channel groups which is switched to the i-th level is a voltage which is compensated by one of the compensation voltages corresponding to the i-th level. i is an integer greater than or equal to 1 and smaller than or equal to N.

### Advantageous Effects

The present disclosure provides a source driver, a display device, and a driving method. The display device includes a display panel and at least one source driver electrically connected to the display panel. The display panel has a display area and at least one fan-shaped area located outside the display area. The display area includes a middle display area and a first display area and a second display area located at opposite sides of the middle display area. A plurality of sub-pixels are disposed in the display area of the display panel. A plurality of wires are disposed in each of the at least one fan-shaped area of the display panel. Each of the at least one source driver includes a plurality of output channel groups. Each of the output channel groups includes at least one output channel Each of the at least one output channel is configured to output a data voltage. Each of the plurality of wires is configured to transmit the data voltage outputted by one of the at least one output channel A part of the plurality of wires are electrically connected to the sub-pixels in the middle display area, a part of the plurality of wires are electrically connected to the sub-pixels in the first display area, and a part of the plurality of wires are electrically connected to the sub-pixels in the second display area. The plurality of output channel groups are provided with at least one multi-level voltage compensation unit. Each of the at least one multi-level voltage compensating unit is configured to output compensation voltages of N levels. N is an integer greater than or equal to 2. When at least one of the plurality of output channel groups is switched to an i-th level of the at least one multi-level voltage compensation unit, at least one data voltage outputted by the at least one output channel of the at least one of the plurality of output channel groups which is switched to the i-th level is a voltage which is compensated by one of the compensation voltages corresponding to the i-th level. i is an integer greater than or equal to 1 and smaller than or equal to N. The output channels of the at least one source driver are grouped into a plurality of groups, and the plurality of output channel groups are provided with at least one multi-level voltage compensation unit. The at least one multi-level voltage compensation unit is configured to output compensation voltages, and then data voltages are outputted. As such, the pixels in the display device can have the same charging voltage in the same time to improve the problem that some pixels are not sufficiently charged due to the different impedances of the wires in the fan-shaped area of the display panel. Since the multi-level voltage compensation unit has a plurality of levels, the multi-level voltage compensation unit can be applied to display panels having different impedance distributions for solving the mura problem due to the different impedances of the wires in fan-shaped areas of different display panels. Furthermore, the multi-level design also can eliminate the difference of different source drivers corresponding to the fan-shaped areas and increase the image quality of display devices with a large size, a high resolution, and a high refresh rate.

### BRIEF DESCRIPTION OF DRAWINGS

FIG. 1 illustrates a schematic diagram of a display device according to one embodiment of the present disclosure.

FIG. 2 illustrates a schematic diagram of an impedance distribution of the wires in the at least one fan-shaped area of the display panel in FIG. 1.

FIG. 3 illustrates a schematic diagram of a display device according to another embodiment of the present disclosure.

FIG. 4 illustrates a multi-level voltage compensation unit in a source driver according to one embodiment of the present disclosure.

FIG. 5 illustrates a schematic diagram of a multi-shift voltage compensation unit for compensating a display device with a V-shaped shift display.

FIG. 6 illustrates a schematic diagram of a multi-shift voltage compensation unit for compensating a display device with an R-shaped shift display.

FIG. 7 illustrates a schematic diagram of a multi-shift voltage compensation unit for compensating a display device with an L-shaped shift display

FIG. 8 illustrates a flowchart of a driving method of a display device according to one embodiment of the present disclosure.

### DETAILED DESCRIPTION OF EMBODIMENTS

The following clearly describes the technical solutions in the embodiments of the present disclosure with reference to the accompanying drawings in the embodiments of the present disclosure. The described embodiments are some rather than all of the embodiments of the present disclosure. All other embodiments obtained by those skilled in the art based on the embodiments of the present disclosure without creative efforts shall fall within the protection scope of the present disclosure.

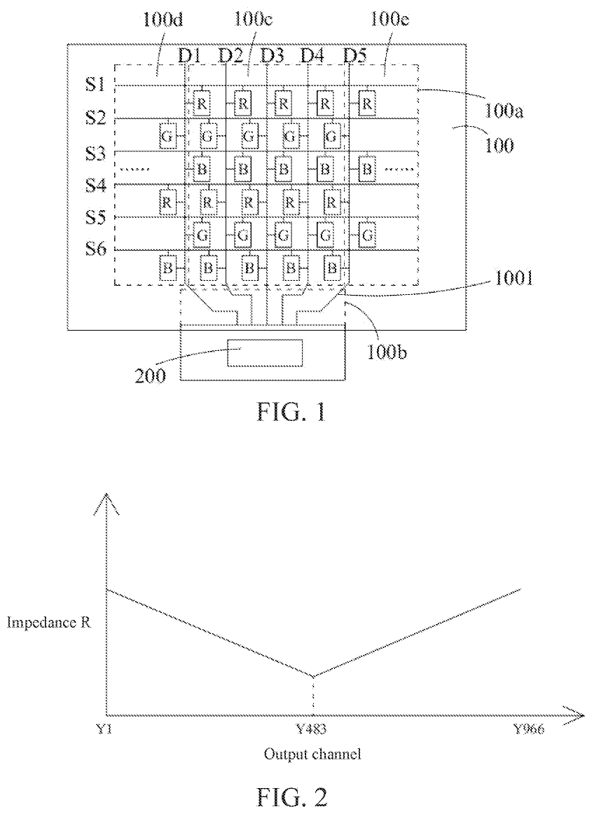

Please refer to FIG. 1. FIG. 1 illustrates a schematic diagram of a display device according to one embodiment of the present disclosure. The display device includes a display panel 100 and at least one source driver 200. The at least one source driver 200 is electrically connected to the display panel 100. The source driver 200 is disposed on a flexible film, and the flexible film is bound to the display panel 100. It can be understood that the source driver 200 can also be directly bound to the display panel 100.

The display panel 100 is configured to display an image. The display panel 100 has a display area 100a and at least one fan-shaped area 100b located outside the display area 100a. A plurality of sub-pixels, a plurality of data lines D, and a plurality of scan lines S are disposed in the display area 100a of the display panel 100. The plurality of data lines D are disposed in parallel and arranged in a row direction. The plurality of scan lines S are disposed in parallel and arranged in a column direction. Each of the plurality of sub-pixels is disposed in an area where two adjacent ones of the plurality of data lines D and two adjacent ones of plurality of scan lines S intersect. The display area 100a includes a middle display area 100c and a first display area 100d and a second display area 100e located at opposite sides of the middle display area 100c. A plurality of wires 1001 are disposed in each of the at least one fan-shaped area 100b of the display panel 100, and each of the plurality of wires 1001 is connected to one of the plurality of data lines D. One end of each of the plurality of sub-pixels is connected to one of the plurality of data lines D, and the other end of each of the plurality of sub-pixels is connected to one of the plurality of scan lines S. A part of the plurality of wires 1001 are electrically connected to the sub-pixels in the middle display area 100c, a part of the plurality of wires 1001 are electrically connected to the sub-pixels in the first display area 100d, and a part of the plurality of wires 1001 are electrically connected to the sub-pixels in the second display area 100e.

FIG. 2 illustrates a schematic diagram of an impedance distribution of the wires in the at least one fan-shaped area of the display panel in FIG. 1. The abscissa in FIG. 2 includes positions of output channels of the at least one source driver, and the ordinate includes impedances of the wires on the display panel corresponding to the output channels of the source driver. It can be understood from FIG. 1 that the display device includes one source driver 200. Correspondingly, the display panel 100 includes one fan-shaped area 100b. It can be understood from FIG. 2 that the source driver 200 includes 966 output channels. Correspondingly, the fan-shaped area 100b is provided with 966 wires 1001. Each of the wires 1001 corresponds to one of the output channels. The impedances of the wires 1001 in the fan-shaped area 100b corresponding to the 1st output channel to the 483rd output channel of the source driver 200 are decreased gradually. The impedances of the wires 1001 in the fan-shaped area 100b corresponding to the 483rd output channel to the 966th output channel of the source driver 200 are increased gradually. The impedance of the wire 1001 in the fan-shaped area 100b corresponding to the 483rd output channel of the source driver 200 is smallest. That is, the impedances of the wires 1001 in two sides of the fan-shaped area 100b are greater than the impedances of the wires 1001 in the center of the fan-shaped area 100b. Accordingly, the impedances of the wires 1001 in the fan-shaped area 100b have larger differences. Since the impedances of the wires 1001 in the fan-shaped area 100b have larger differences, data voltages transmitted via the wires in the fan-shaped area 100b with different impedances in the conventional technology have different charging voltages for the sub-pixels in the same time. Specifically, charging states of the sub-pixels in the first display area 100d and in the second display area 100e and charging states of the sub-pixels in the middle display area 100c are different.

As shown in FIG. 1, when the display panel is a tri-gate display panel, the sub-pixels having the same color in the tri-gate display panel are connected to the same scan line S. One red sub-pixel R, one green sub-pixel G, and one blue sub-pixel B located in the same column are served as one repetition unit which is connected to two adjacent ones of the plurality of data lines D. In the conventional technology, for the tri-gate display panel, charging of the sub-pixels connected to the data lines D connected to the wires 1001 in two sides of the fan-shaped area 100b (the sub-pixels in the first display area 100d and the second display area 100e) is insufficient when compared with charging of the sub-pixels connected to the data lines D connected to the wires 1001 in the center of the fan-shaped area 100b (the sub-pixels in the middle display area 100c). This causes the color shift problem in both sides of the panel when a mixed-color image is displayed. That is, a V-type shift display problem occurs. Specifically, the sub-pixels in the first display area 100d and the second display area 100e are insufficiently charged with respect to the sub-pixels in the middle display area 100c. This causes the V-type shift display problem. The first display area 100d, the second display area 100e, and the middle display area 100c all include a plurality of columns of sub-pixels.

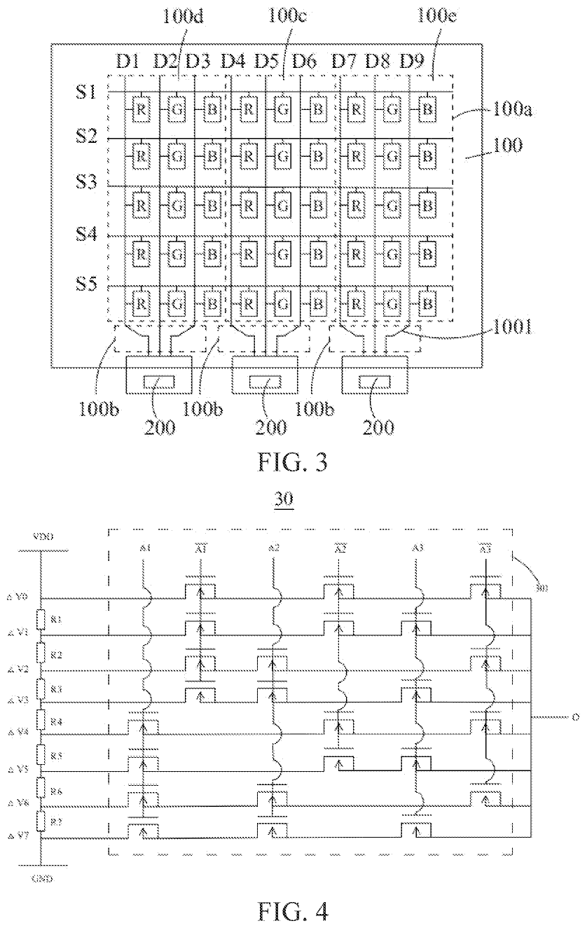

FIG. 3 illustrates a schematic diagram of a display device according to another embodiment of the present disclosure. The display device is an 8K high-resolution display device adopting a 1G1D architecture. The display device includes a plurality of source drivers 200 and a display panel 100. In the display panel 100, sub-pixels in the same row are connected to the same scan line S, and sub-pixels in the same column are connected to the same data line D. One red sub-pixel, one green sub-pixel, and one blue sub-pixel in the same row of sub-pixels are served as one repetition unit and sequentially connected to the same scan line S. For ease of description, three source drivers 200 are taken as an example. However, a number of the source drivers 200 is not limited to three. The display panel 100 includes three fan-shaped areas 100b. Wires 1001 in one of the three fan-shaped areas 100b are electrically connected to the sub-pixels in the first display area 100d. Wires 1001 in another of the three fan-shaped areas 100b are electrically connected to the sub-pixels in the second display area 100e. Wires 1001 in the other of the three fan-shaped areas 100b are electrically connected to the sub-pixels in the middle display area 100c. The impedance distribution of the wires in each of the three fan-shaped areas 100b is shown in FIG. 2. That is, the impedances of the wires in both sides of each of the three fan-shaped areas 100b are large, and the impedances of the wires in the center of each of the three fan-shaped areas 100b are small. The first display area 100d, the second display area 100e, and the middle display area 100c all include a plurality of columns of sub-pixels. In other embodiments, the display area of the display panel 100 can also be divided into more than three according to the resolution of the display panel and a number of output channels of each of the source drivers. The display panel of the high-resolution display device includes a plurality of fan-shaped areas 100b. The impedances of the wires 1001 in each of the fan-shaped areas 100b have differences, and the impedances of the wires 1001 in different the fan-shaped areas 100b also have differences. The high-resolution display device includes a large number of the source drivers 200. Different source drivers have different charging situations. This causes the mura problem in one side when an image is displayed. For example, an R-type shift display problem or an L-type shift display problem occurs. Specifically, the color shift apparently appears in the first display area 100d or in the second display area 100e.

Regarding the mura problem resulted from insufficient charging caused by the impedance differences of the wires in each of the fan-shaped areas 100b and the charging ability differences of the source drivers 200, each of the source drivers 200 of the present disclosure includes a plurality of output channel groups. Each of the plurality of output channel groups includes at least one output channel Each of the at least one output channel is configured to output a data voltage. Each of the plurality of wire 1001 is configured to transmit the data voltage outputted by one of the at least one output channel. The plurality of output channel groups are provided with at least one multi-level voltage compensation unit 30. Each of the at least one multi-level voltage compensating unit 30 is configured to output compensation voltages of N levels. N is an integer greater than or equal to 2. When at least one of the plurality of output channel groups is switched to an i-th level of the at least one multi-level voltage compensation unit 30, at least one data voltage outputted by the at least one output channel of the at least one output channel group which is switched to the i-th level is a voltage which is compensated by one of the compensation voltages corresponding to the i-th level, where i is an integer greater than or equal to 1 and smaller than or equal to N.

The source driver of the present disclosure groups the output channels in the source driver 200, so that the data voltages outputted by the output channels can be adjusted in units of groups to compensate the display panel 100 according to different areas. Furthermore, the at least one multi-level voltage compensation unit 30 is disposed for the plurality of output channel groups. When at least one output channel group is switched to the i-th level of the at least one multi-level voltage compensation unit 30, the multi-level voltage compensation unit 30 compensates, with the compensation voltage corresponding to the i-th level, the voltage outputted by at least one output channel in the at least one output channel group which is switch to the i-th level and then outputs the data voltage, thereby solving the charging differences of the pixels of the display panel due to the impedance differences when the data voltages are outputted by the output channels in the different output channel groups. As such, the sub-pixels in different areas of the display panel (the middle display area 100c and the first display area 100d and the second display area 100e at opposite sides of the middle display area 100c) have the same charging voltage for the same time, so as to prevent the display panel 100 from occurring the mura problem. Furthermore, since the multi-level voltage compensation unit has a plurality of levels, the multi-level voltage compensation unit can be suitable for solving the problem of insufficient charging of pixels caused by the impedance differences in each of the fan-shaped areas 100b of the display panel 100, cab be applied to display panels having different impedance distributions, and can be suitable for solving the problem of the charging ability differences of the source drivers.

In the present embodiment, the output channel groups can include the same number of the at least one output channel. For example, the 1st output channel group includes the 1st output channel to the 12th output channel, and the second 2nd output channel group includes the 13th output channel to the twenty-fourth output channel. The rest can be deduced by analogy. In other embodiments, the output channel groups can include different numbers of the at least one output channel. The output channel groups are grouped based on a total number of output channels of all source drivers in the display panel.

In the present embodiment, in the same multi-level voltage compensation unit 30, difference values of the compensation voltages corresponding to two adjacent levels are equal to simplify the design of the multi-level voltage compensation unit. The values of the compensation voltages corresponding to the N levels in the multi-gear voltage compensation unit 30 increase or decrease gradually.

In the present embodiment, one multi-level voltage compensation unit 30 is provided between two adjacent ones of the output channel groups, so that the charging differences of the sub-pixels of the display panel can be compensated by the data voltages outputted by the output channels in the two adjacent ones of the output channel groups after one of the two adjacent ones of the output channel groups is switched to the multi-level voltage compensation unit 30. A level design of any two multi-level voltage compensation units 30 can be the same or different and can be designed according to the actual impedance differences of the display panel, the impedance differences of the source drivers, and the resolution of the display device. The present disclosure is not limited thereto.

It should be noted that a number of levels of the compensation voltages outputted by each multi-level voltage compensation unit 30, a value of a compensation voltage corresponding to each level, and a number of the output channel groups in each of the source drivers 200 are mainly related to the impedance differences of the wires in each of the fan-shaped areas 100b. When the number of the output channel groups is more, it is more advantageous for compensating the mura problem of the display panel according to different areas. However, when the number of the output channel groups is more, the cost of each of the source drivers is higher. When the number of levels of the compensation voltages included in each multi-level voltage compensation unit 30 is more and a difference of values of compensation voltages between two adjacent levels is smaller, it is more advantageous for compensating the mura problem of the display panel. However, when the number of levels of the compensation voltages is more or the difference of the values of the compensation voltages between the two adjacent levels is smaller, the cost of each of the source drivers is higher.

In the present embodiment, each multi-level voltage compensation unit 30 includes a ground terminal GND, a voltage level input terminal VDD, a plurality of voltage dividing units R, and a plurality of voltage level output terminals. The plurality of voltage dividing units R are connected in series between the ground terminal GND and the voltage level input terminal VDD. Each of the voltage level output terminals is disposed between two adjacent ones of the voltage dividing units R. Each of the plurality of voltage level output terminal is drawn between two adjacent ones of the voltage dividing units R, so that the values of the compensation voltages having different levels can be outputted. Voltage values of the plurality of voltage dividing units R are the same.

One multi-level voltage compensation unit 30 having 8 levels is described as follows. A number of levels of the multi-level voltage compensation unit 30 is not limited to 8 levels. The number of levels can be greater than or equal to 2, for example, three levels or four levels.

FIG. 4 illustrates a multi-level voltage compensation unit in a source driver according to one embodiment of the present disclosure. The multi-level voltage compensation unit 30 shown in FIG. 4 can output compensation voltages of eight different levels including ΔV0, ΔV1, ΔV2, ΔV3, ΔV4, ΔV5, ΔV6, and ΔV7. Values of the compensation voltage corresponding to the eight different levels ΔV0, ΔV1, ΔV2, ΔV3, ΔV4, ΔV5, ΔV6, and ΔV7 are decrease gradually, and a difference value between two adjacent levels is equal. The voltage level input terminal VDD is configured to input a direct current high voltage level. The voltage level input terminal VDD is connected to the ground terminal GND. The plurality of voltage dividing units R are all resistors, and corresponding resistance values of the plurality of voltage dividing units R are equal. The plurality of voltage dividing units R are connected in series between the voltage level input terminal VDD and the ground terminal GND. One voltage level output terminal is disposed between two adjacent ones of the voltage dividing units R for outputting a compensation voltage having a level.

The multi-level voltage compensation unit 30 further includes a selection unit 301 configured to output one value of one compensation voltage corresponding to one of the N levels to an output terminal O. The selection unit 301 includes at least one switch unit connected to each of the voltage level output terminals. The switch unit is configured to control whether one compensation voltage corresponding to one level of one of the voltage level output terminals is outputted to the output terminal O under control of at least one control signal. The output channel groups are connected to the output terminal O of the multi-level voltage compensation unit 30, so that the selection unit 301 is controlled to compensate the at least one output channel of one of the output channel groups by one compensation voltage corresponding to one level. For example, the selection unit 301 is a 3-bit design. Each of the voltage level output terminals is connected to three switches. The selection unit 301 can control to output one of the compensation voltages having 8 different levels. The switch unit can include a plurality of metal oxide semiconductor (MOS) tubes.

In the following example, a total number of the output channels of one source driver or a plurality of source drivers is 966. In the most groups, twelve output channels are grouped into one group. The values of the compensation voltages from the 481st output channel to the 486th output channel are the same. That is, one output channel group includes the 481st output channel to the 486th output channel Scheme for compensating the V-type shift display, the L-type shift display, and the R-type shift display using the multi-level voltage compensation unit are described as follows.

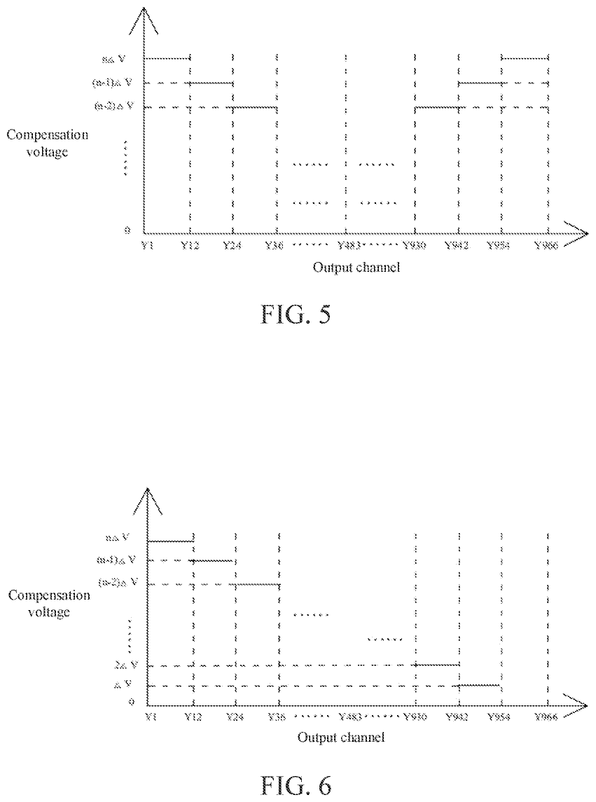

Please refer to FIG. 5. FIG. 5 illustrates a schematic diagram of a multi-shift voltage compensation unit for compensating a display device with a V-shaped shift display. It can be seen from FIG. 5 that twelve output channels are grouped into one group. One group includes the 1st output channel to the 12th output channel Data voltages from the 1st output channel to the 12th output channel are outputted after the 1st output channel to the 12th output channel are compensated by nΔV. Data voltages from the 13th output channel to the 24th output channel are outputted after the 13th output channel to the 24th output channel are compensated by (n−1)ΔV. A different value of the compensation voltages between two adjacent ones of the output channel groups is ΔV. A value of the compensation voltage of the 483rd output channel is zero. The values of the compensation voltages of switching to levels of the at least one multi-level voltage compensation unit 30 are decreased gradually in a direction from the first display area 100d of the display panel and the second display area 100e to the middle display area 100c.

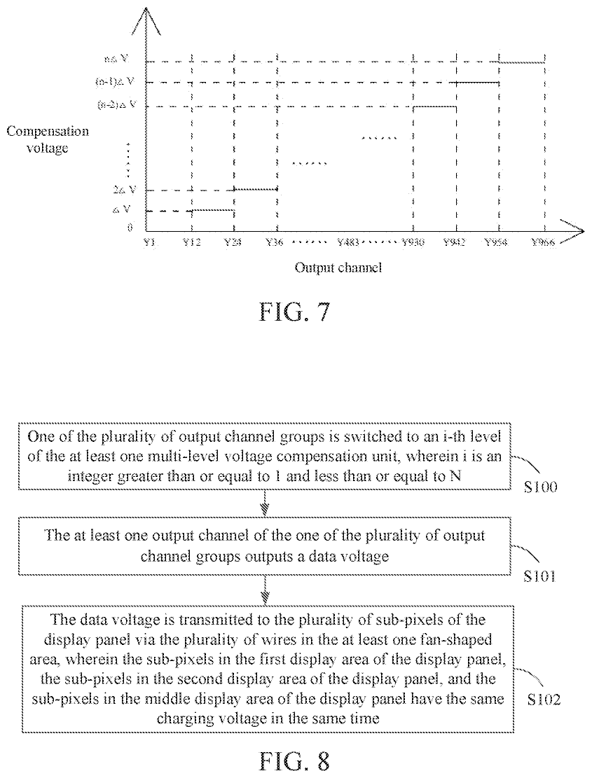

Please refer to FIG. 6 and FIG. 7. FIG. 6 illustrates a schematic diagram of a multi-shift voltage compensation unit for compensating a display device with an R-shaped shift display. FIG. 7 illustrates a schematic diagram of a multi-shift voltage compensation unit for compensating a display device with an L-shaped shift display. Schematic diagram of compensation. For the display devices with the R-type shift display problem, a value of the compensation voltage from the 1st output channel to the 12th output channel is nΔV. A value of the compensation voltage from the 13th output channel to the 24th output channel is (n−1)ΔV. A value of the compensation voltage from the 954th output channel to the 966th output channel is 0. The values of the compensation voltages are decreased gradually in a direction from the 1st output channel of the source driver 200 to the 966th output channel. The values of the compensation voltages of switching to levels of the multi-level voltage compensation unit 30 are decreased gradually in a direction from the first display area 100d of the display panel 100 to the second display area 100e. For the display devices with the L-type shift display problem, a value of the compensation voltage from the 1st output channel to the 12th output channel is 0. A value of the compensation voltage from the 954th output channel to the 966th output channel is nΔV. The values of the compensation voltages in a direction from the 1st output channel of the source driver to the 966th output channel are increased gradually. The values of the compensation voltages of switching to level of the multi-level voltage compensation unit 30 in a direction from the first display area 100d of the display panel 100 to the second display area 100e are increased gradually.

Furthermore, the multi-level voltage compensation unit 30 in the source driver of the present disclosure can solve the mura problem of the display device in combination with the output data delay compensation method in the traditional technology. Since the display effect of the display device is related to the charging time of each pixel and also related to the charging voltage of each pixel, the output channel groups of the present disclosure are switched to the levels of the multi-level voltage compensation unit 30 and adjusted to solve the mura problem of the display device which still exists when the at least one source driver adopts the output data delay compensation function. The data voltages of the output channels of the source driver are adjusted to improve the mura problem which is caused by the insufficient charging and still exists when the at least one source driver adopts the output data delay compensation function.

The present disclosure further provides a driving method of a display device to solve the problem that the charging voltages for the sub-pixels in the same time are different due to the different impedances in the traditional display devices and to avoid the problem that the mura problem occurs in the traditional display devices when an image is displayed. The display device includes a display panel and at least one source driver electrically connected to the display panel. The display panel has a display area and at least one fan-shaped area located outside the display area. The display area includes a middle display area and a first display area and a second display area located at opposite sides of the middle display area. A plurality of sub-pixels are disposed in the display area of the display panel. A plurality of wires are disposed in each of the at least one fan-shaped area of the display panel. The at least one source driver includes a plurality of output channel group. Each of the plurality of output channel groups includes at least one output channel Each of the at least one output channel is electrically connected to a corresponding one of the plurality of wires. A part of the plurality of wires are electrically connected to the sub-pixels in the middle display area, a part of the plurality of wires are electrically connected to the sub-pixels in the first display area, and a part of the plurality of wires are electrically connected to the sub-pixels in the second display area. The plurality of output channel groups are provided with at least one multi-level voltage compensation unit. Each of the at least one multi-level voltage compensating unit is configured to output compensation voltages of N levels. N is an integer greater than or equal to 2. FIG. 8 illustrates a flowchart of a driving method of a display device according to one embodiment of the present disclosure. The driving method includes the following steps.

In step S100, one of the plurality of output channel groups is switched to an i-th level of the at least one multi-level voltage compensation unit, wherein i is an integer greater than or equal to 1 and less than or equal to N.

In step S101, the at least one output channel of the one of the plurality of output channel groups outputs a data voltage.

In step S102, the data voltage is transmitted to the plurality of sub-pixels of the display panel via the plurality of wires in the at least one fan-shaped area, wherein the sub-pixels in the first display area of the display panel, the sub-pixels in the second display area of the display panel, and the sub-pixels in the middle display area of the display panel have the same charging voltage in the same time.

The data voltage outputted by the at least one output channel of the one of the plurality of output channel groups which is switched to the i-th level is a voltage which is compensated by one of the compensation voltages corresponding to the i-th level.

In order to solve the V-shaped shift display problem in the traditional display devices, values of the compensation voltages of switching the plurality of output channel groups of the at least one source driver to levels of the at least one multi-level voltage compensation unit are decreased gradually in a direction from the first display area of the display panel and the second display area to the middle display area.

In order to solve the R-type shift problem or the L-type shift display problem of the traditional high-resolution display devices (for example, 1G1D 8K display devices), values of the compensation voltages of switching the plurality of output channel groups of the at least one source driver to levels of the at least one multi-level voltage compensation unit are decreased or increased gradually in a direction from the first display area of the display panel to the second display area. The R-type shift problem or the L-type shift display problem refers to that the mura phenomenon is strengthened from one side of the display device to the other side. Correspondingly, the values of the compensation voltages are also increased from one side to the other side.

In the present embodiment, the at least one multi-level voltage compensation unit is provided between two adjacent ones of the plurality of output channel groups.

In the present embodiment, each of the at least one multi-level voltage compensation unit includes a ground terminal, a voltage level input terminal, a plurality of voltage dividing units, and a plurality of voltage level output terminals. The plurality of voltage dividing units are connected in series between the ground terminal and the voltage level input terminal. Each of the plurality of voltage level output terminals is disposed between two adjacent ones of the voltage dividing units.

The descriptions of the above-mentioned embodiments are only used for helping to understand the technical solution of the present disclosure and its core idea. Those skilled in the art should understand that it can still modify the technical solutions described in the above-mentioned embodiments, or replace some of the technical features. The modifications or substitutions do not depart from the scope of the technical solutions of the embodiments of the present disclosure.

What is claimed is:

1. A display device, wherein the display device comprises a display panel and at least one source driver electrically connected to the display panel, the display panel has a display area and at least one fan-shaped area located outside the display area, the display area comprises a middle display area and a first display area and a second display area located at opposite sides of the middle display area, a plurality of sub-pixels are disposed in the display area of the display panel, a plurality of wires are disposed in each of the at least one fan-shaped area of the display panel, each of the at least one source driver comprises a plurality of output channel groups, each of the output channel groups comprises at least one output channel, each of the at least one output channel is configured to output a data voltage, each of the plurality of wires is configured to transmit the data voltage outputted by one of the at least one output channel, a part of the plurality of wires are electrically connected to the sub-pixels in the middle display area, a part of the plurality of wires are electrically connected to the sub-pixels in the first display area, and a part of the plurality of wires are electrically connected to the sub-pixels in the second display area;
the plurality of output channel groups are provided with at least one multi-level voltage compensation unit, and each of the at least one multi-level voltage compensating unit is configured to output compensation voltages of N levels, wherein N is an integer greater than or equal to 2; and
when at least one of the plurality of output channel groups is switched to an i-th level of the at least one multi-level voltage compensation unit, at least one data voltage outputted by the at least one output channel of the at least one of the plurality of output channel groups which is switched to the i-th level is a voltage which is compensated by one of the compensation voltages corresponding to the i-th level, wherein i is an integer greater than or equal to 1 and smaller than or equal to N.

2. The display device of claim 1, wherein in the same multi-level voltage compensation unit, difference values of the compensation voltages corresponding to two adjacent levels are equal.

3. The display device of claim 1, wherein the at least one multi-level voltage compensation unit is provided between two adjacent ones of the plurality of output channel groups.

4. The display device of claim 1, wherein each of the at least one multi-level voltage compensation unit comprises a ground terminal, a voltage level input terminal, a plurality of voltage dividing units, and a plurality of voltage level output terminals, the plurality of voltage dividing units are connected in series between the ground terminal and the voltage level input terminal, and each of the plurality of voltage level output terminals is disposed between two adjacent ones of the plurality of voltage dividing units.

5. A driving method of a display device, wherein the display device comprises a display panel and at least one source driver electrically connected to the display panel, the display panel has a display area and at least one fan-shaped area located outside the display area, the display area comprises a middle display area and a first display area and a second display area located at opposite sides of the middle display area, a plurality of sub-pixels are disposed in the display area of the display panel, a plurality of wires are disposed in each of the at least one fan-shaped area of the display panel, each of the at least one source driver comprises a plurality of output channel groups, each of the output channel groups comprises at least one output channel, each of the at least one output channel is electrically connected to a corresponding one of the plurality of wires, a part of the plurality of wires are electrically connected to the sub-pixels in the middle display area, a part of the plurality of wires are electrically connected to the sub-pixels in the first display area, a part of the plurality of wires are electrically connected to the sub-pixels in the second display area, the plurality of output channel groups are provided with at least one multi-level voltage compensation unit, and each of the at least one multi-level voltage compensating unit is configured to output compensation voltages of N levels, wherein N is an integer greater than or equal to 2;
the method comprises steps of:
switching one of the plurality of output channel groups to an i-th level of the at least one multi-level voltage compensation unit, wherein i is an integer greater than or equal to 1 and less than or equal to N;
outputting a data voltage by the at least one output channel of the one of the plurality of output channel groups; and
transmitting the data voltage to the plurality of sub-pixels of the display panel via the plurality of wires in the at least one fan-shaped area, wherein the sub-pixels in the first display area of the display panel, the sub-pixels in the second display area of the display panel, and the sub-pixels in the middle display area of the display panel have the same charging voltage in the same time;
wherein the data voltage outputted by the at least one output channel of the one of the plurality of output channel groups which is switched to the i-th level is a voltage which is compensated by one of the compensation voltages corresponding to the i-th level.

6. The driving method of the display device of claim 5, wherein values of the compensation voltages of switching the plurality of output channel groups of the at least one source driver to levels of the at least one multi-level voltage compensation unit are decreased gradually in a direction from the first display area of the display panel and the second display area to the middle display area.

7. The driving method of the display device of claim 5, wherein values of the compensation voltages of switching the plurality of output channel groups of the at least one source driver to levels of the at least one multi-level voltage compensation unit are decreased or increased gradually in a direction from the first display area of the display panel to the second display area.

8. The driving method of the display device of claim 5, wherein the at least one multi-level voltage compensation unit is provided between two adjacent ones of the plurality of output channel groups.

9. The driving method of the display device of claim 5, wherein each of the at least one multi-level voltage compensation unit comprises a ground terminal, a voltage level input terminal, a plurality of voltage dividing units, and a plurality of voltage level output terminals, the plurality of voltage dividing units are connected in series between the ground terminal and the voltage level input terminal, and each of the plurality of voltage level output terminals is disposed between two adjacent ones of the plurality of voltage dividing units.

10. A source driver, wherein the source driver comprises a plurality of output channel groups, each of the output channel groups comprises at least one output channel, and each of the at least one output channel is configured to output a data voltage;
the plurality of output channel groups are provided with at least one multi-level voltage compensation unit, and each of the at least one multi-level voltage compensating unit is configured to output compensation voltages of N levels, wherein N is an integer greater than or equal to 2; and
when at least one of the plurality of output channel groups is switched to an i-th level of the at least one multi-level voltage compensation unit, at least one data voltage outputted by the at least one output channel of the at least one of the plurality of output channel groups which is switched to the i-th level is a voltage which is compensated by one of the compensation voltages corresponding to the i-th level, wherein i is an integer greater than or equal to 1 and smaller than or equal to N.

11. The source driver of claim 10, wherein in the same multi-level voltage compensation unit, difference values of the compensation voltages corresponding to two adjacent levels are equal.

12. The source driver of claim 10, wherein the at least one multi-level voltage compensation unit is provided between two adjacent ones of the plurality of output channel groups.

13. The source driver of claim 10, wherein the plurality of output channel groups are provided with a plurality of multi-level voltage compensation units, and each of the plurality of output channel groups comprises a plurality of output channels configured to output data voltages.

14. The source driver of claim 10, wherein each of the at least one multi-level voltage compensation unit comprises a ground terminal, a voltage level input terminal, a plurality of voltage dividing units, and a plurality of voltage level output terminals, the plurality of voltage dividing units are connected in series between the ground terminal and the voltage level input terminal, and each of the plurality of voltage level output terminals is disposed between two adjacent ones of the plurality of voltage dividing units.

15. The source driver of claim 14, wherein the plurality of voltage dividing units are all resistors.
